(19) United States
(12) Patent Application Publication
(10) Pub. No.: US 2013/0124708 A1
(43) Pub. Date: May 16, 2013

(54) METHOD AND SYSTEM FOR ADAPTIVE COMPOSITE SERVICE PATH MANAGEMENT

(71) Applicant: Electronics and Telecommunications Research, Daejeon (KR)

(72) Inventors: Seung-ik LEE, Daejeon (KR); Jong Hwa YI, Daejeon (KR); Shin Gak KANG, Daejeon (KR)

(73) Assignee: Electronics and Telecommunications Research Institute, Daejeon (KR)

(21) Appl. No.: 13/673,127

(22) Filed: Nov. 9, 2012

(30) Foreign Application Priority Data
Nov. 10, 2011 (KR) 10-2011-0117088
Jun. 14, 2012 (KR) 10-2012-0063873

(51) Int. Cl. G06F 15/173

(52) U.S. Cl. CPC H04L 65/40
USPC 709/223

(57) ABSTRACT

A system for adaptive composite service path management includes a service path control function module configured to search for and select component services according to a template of a composite service and generate a service chain and a service path on the basis of collected contexts from user, service and network. A service binding module is configured to call the component services according to the service path and execute the template of the composite service.

### RELATED APPLICATION(S)

This application claims the benefit of Korean Patent Application Nos. 10-2011-0117088, filed on Nov. 10, 2011, and 10-2012-0063873, filed on Jun. 14, 2012, which are hereby incorporated by reference as if fully set forth herein.

### FIELD OF THE INVENTION

The present invention relates to a service overlay networking (SON) technology, and more specifically to a system and a method for adaptive composite service path management and method, which is adapted to optimize a user's quality of experience (QoE) utilizing context when selecting a service component for a service combination.

### BACKGROUND OF THE INVENTION

In general, a service overlay networking (SON) technology refers to a technology that constructs a virtual logical network on a physical network and efficiently provides the most appropriate service or content to the demand of users. Such a service overlay networking technology is extending and developing to a service/context recognition-based active overlay networking technology in order to satisfy changing requirements such as a user's preference, and capability and characteristic of terminal in search and combination of distributed services. In a service overlay networking technology, in order to maximize a user's QoE (Quality of Experience) when combining service components that construct a composite service, a technology of constructing an adaptive service chain is used, in which the service components are differently selected and combined on the basis of a user's context.

However, since the user's QoE is of human feeling, there is a problem that it is difficult to objectively evaluate performance of a QoE provided by service components using a simple QoS measuring method using an existing network transfer performance or the like. Especially, when considering diversified service characteristics demanded according to surrounding context, there is an urgent need for arranging an objective and adaptive evaluation reference for that.

### SUMMARY OF THE INVENTION

In view of the above, the present invention provides a technology for defining a metric (experience element or quality element) of a service component reflecting a quality of experience (QoE) of a user and measuring and evaluating the metric adaptively according to surrounding situation or context in order to construct a service chain.

In accordance with an aspect of the present invention, there is provided a system for adaptive composite service path management, which includes: a service path control function module configured to search for and select component services according to a template of a composite service and generate a service chain and a service path on the basis of collected contexts from user, service and network; and a service binding module configured to call the component services according to the service path and execute the template of the composite service.

In accordance with another aspect of the present invention, there is provided a method for an adaptive composite service path management, which includes: collecting context for user, service and network in response to a request of a composite service; extracting a type of the service by analyzing a template of the composite service, and producing candidate services by searching for component service instances appropriate to the type of the service that are extracted with reference to the collected context; producing a service graph by mapping the candidate services produced according to the type of the service for the service template requested by the composite service; constructing a service chain by selecting component services appropriate to execution of the composite service from the service graph according to a requirement and a current context requested by the composite service; determining a service path between service nodes on which component services operate, the component services being selected with reference to a context of a network; calling the component services according to the service path determined to execute the template of the composite service.

In accordance with the present invention, there are merits of selecting a service with which a user's quality of experience (QoE) is optimized by applying service performance elements differently according to contexts such as user, service and network, providing an optimized service of a dynamic context change through change of the service performance elements with respect to change of context, providing more optimized service by expanding performance metric and metric factor according to a variety of services and user's requirements, and realizing more various and detailed requirements through change of metric combination rule and factor combination rule.

### BRIEF DESCRIPTION OF THE DRAWINGS

The above and other objects and features of the present invention will become apparent from the following description of embodiments given in conjunction with the accompanying drawings, in which:

FIG. 1 illustrates a schematic block diagram of a system for adaptive composite service path management in accordance with the present invention;

FIG. 2 illustrates a detailed block diagram of a system for adaptive composite service path management in accordance with the present invention;

FIG. 3 is an exemplary diagram illustrating a process in which a performance metric determination block illustrated in FIG. 2 determines a 2-level performance element;

FIG. 4 is an exemplary diagram in which a service chain is constructed by applying a method for selecting performance metric and factor in accordance with the present invention;

FIG. 5 is a diagram defining main performance indices and measuring factors that are applicable to the present invention;

FIG. 6 is an exemplary diagram illustrating a combination of a performance metric according to service component and user context (PSTARC); and

FIG. 7 is a diagram illustrating an example in which a service chain is adaptively constructed and a service is provided depending on a context in a method for adaptive composite service path management in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

First, for the better understanding of exemplary embodiments of the present invention, terms and components used in the exemplary embodiment are defined as follows.

Service

It is a group of a series of functions, which is divided into a component service and a composite service, such services being installed and operated independently in a distributed application server.

Component service

It means a service in a component unit that provides a complete function, which has actual function and capability. A component service type (format) describes an interface and an expected operation of a specific component service, and a component service instance means a service that satisfies a type of the specific component service and is installed in an application server, thereby being operated and available actually.

Composite Service

It is a service that can be completed by interconnecting and combining component services operating independently in the order of a series of operations in order to meet object and requirement of the services. The composite service includes a service template representative of a specification for a combination of component services.

Context

It means all environmental factors for the subject of information, which affects an operation of system. There exist contexts for service, network and user.

Exemplary service contexts may be: Service-related information such as service QoS, service performance, service availability, service roaming state, service triggers (such as policies, user feedback, and location), content, service category, service fees, service provider, and location where the service is available.

Exemplary network contexts may be: Network-related information such as network conditions (e.g., bandwidth, traffic topology) and performance.

Exemplary user contexts may be: User-related information such as location, environment constraint, terminal equipment used, preference, presence.

Composite Context

It is a context that affects construction and operation of a service, which means a composite rule that is expressed as a logical combination or a semantic combination of an individual context.

End-user

It means a terminal-based user that actually requests and utilizes a composite service.

Interaction

It means that two component services interact with each other to embody a composite service. That is, service-to-service in which an output interface and an input interface connect and interact with each other, for example.

All of such interactions are relayed and transferred by a context-aware service overlay network (CSON) node.

Service Template

It means a logical specification defining a type of component services that construct a composite service, and interconnection type and operation order of the component services. Generally, the service template is made by specifying a service logic using a user-friendly tool.

Service Graph

It means a group of service chains that accord with a service template of a composite service and can be constructed of currently available component services, wherein many service chains can be generated for one service template.

Service Chain

It means a logical connection of available component services that accord with format and connection type defined in a service template of a composite service. It also means an instance of the service template in which the component services selected actually are bound.

Service Path

It means a routing path for service interactions between CSON nodes and application servers having component services installed therein which realize a service chain.

Service Provider

It means a business operator that develops and provides a component and a composite service and creates profit accordingly. It provides and operates an application server in which a service operates, manufactures and provides a new type of component service and an existing type of component service, and creates a new composite service by manufacturing a service template.

Network Provider

It means a business operator that operates and provides an underlying transport network service and creates profit accordingly.

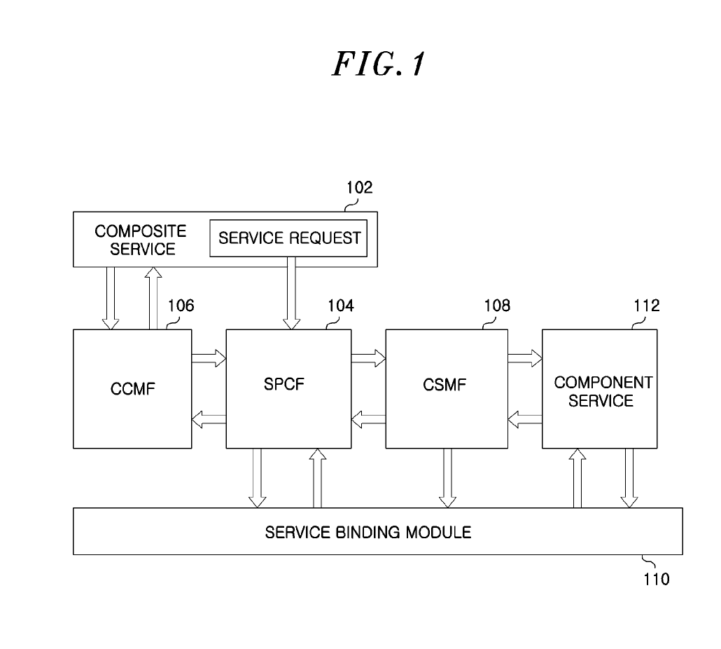

FIG. 1 illustrates a schematic block diagram of a system for adaptive composite service path management in accordance with an exemplary embodiment. The system includes a composite service 102, a service path control function (SPCF) module 104, a context management function (CCMF) module 106, a component service management function (CSMF) module 108, a service binding module 110, and a component service 112.

Referring to FIG. 1, the composite service 102 means service that can be completed by interconnecting and combining component services each of which operates independently in the order of a series of operations to meet objects and requirements of the component services. The composite service 102 is a logical service whose actual functionality may be embodied by combining and executing the component services. Further, the composite service 102 may include a representation for a combination of the component services, that is, interconnection type and operation order of the component services, which is herein called ‘service template’. In addition, the composite service 102 is embodied on an arbitrary node within an application server or a service overlay network.

The composite service 102, in order to meet a request of user and application program, transfers a service template constructed in advance to the system for service path management and requests the system to perform the service template. The service template is a specification that describes a list of component service types which are basic units that can be executed through the system for service path management and interconnection state and operation order thereof. The template of the composite service 102 may include a specification portion to describe its service logic using business process execution language (BPEL) and a specification portion to describe the component service types using Web application description language (WADL).

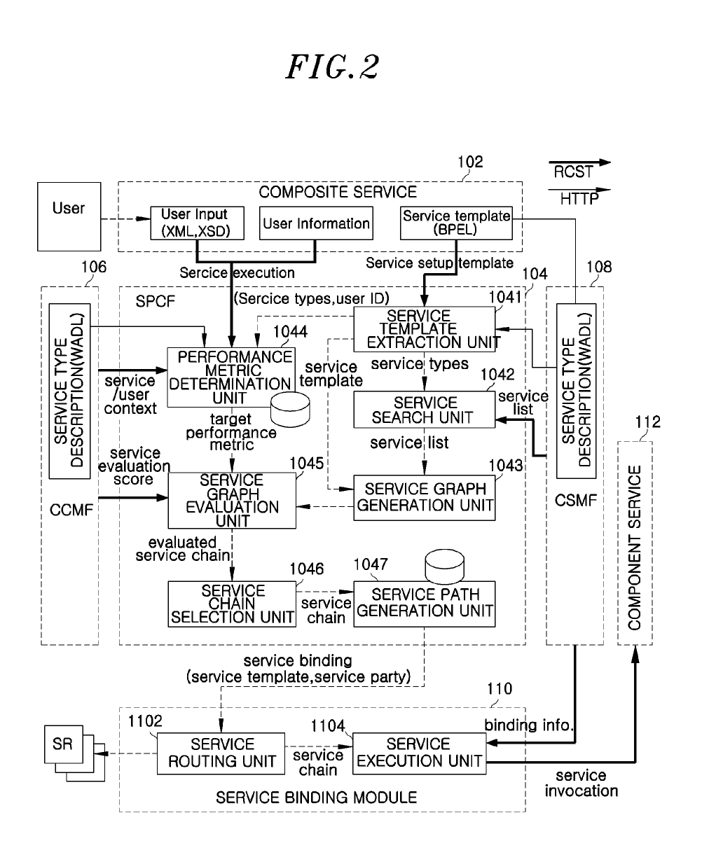

The SPCF module 104 provides functions such as searching for and selecting component services according to a template of the composite service 102, and generating a service chain and a service path based on the collected context information about users, services and networks. The SPCF module 104 provides different functions such as analyzing the template of the composite service, extracting the service type and then obtaining a list of component service instances appropriate to the extracted service type, generating a service graph with the obtained component service instances, and determining a service chain by utilizing the context of user and service. Such functions will be described in detail below with reference to FIG. 2.

The CCMF module 106 provides a function to manage and store performance index of each component service, context for user/service/network and evaluation score information, for example, and all kinds of information managed here is provided to the SPCF module 104 to embody an exemplary embodiment of the present invention.

The CSMF module 108 provides a function to manage and store information on the component service type, component service information according to the component service type, and binding information of the component service, for example. All of the information managed in the CSMF module 108 is selectively provided to the SPCF module 104 and the service binding module 110 to realize an exemplary embodiment of the present invention.

The service binding module 110 can provide functions such as calling component services according to a service path generated by the SPCF module 104 and executing templates of the composite services, and detailed functions will be described later with reference to FIG. 2.

As set forth above, the component service refers to services of component units, each of which provides a complete functionality and has actual functionality and capability. Each of component services is independently installed and operated in a distributed application server. In the component service, the component service type describes an interface and expected operation of a specific component service, and the component service instance means a service that satisfies a format of a specific component service and is installed in an application server (for example, Google's server, DAUM's server and NAVER's server), capable of being operated and available actually.

FIG. 2 illustrates a detailed block diagram of the system shown in FIG. 1. The SPCF module 104 includes a service template extraction unit 1041, a service discovery unit 1042, a service graph generation unit 1043, a performance metric decision unit 1044, a service graph evaluation unit 1045, a service chain selection unit 1046, and a service path generation unit 1047.

The service template extraction unit 1041 provides functions such as extracting a list of component service types from a template of the composite service 102, and the extracted service type is then transferred to the service search unit 1042.

The service search unit 1042 provides functions such as obtaining a list of component service instances appropriate to the component service type extracted by the service template extraction unit 1041 from the CSMF module 108 and transferring the obtained service instance list to the service graph generation unit 1043. In other words, the service search unit 1042 searches for component service instances that accord to the component service type described in the service template and produces candidate services. To do it, the service search unit 1042 compresses or restricts a candidate service group with reference to the related context from a context manager. For example, when the service type is a motion picture service, the instance may be a moving picture available from the You-Tube, NAVER, DAUM and so on.

Further, the service graph generation unit 1043 provides functions such as constructing a combination of component service instances, that is, mapping the candidate services derived from the service search unit 1042 according to the component service type specified in the service template requested by the composite service to produce a service graph that is a group of the component services capable of embodying the requested composite service.

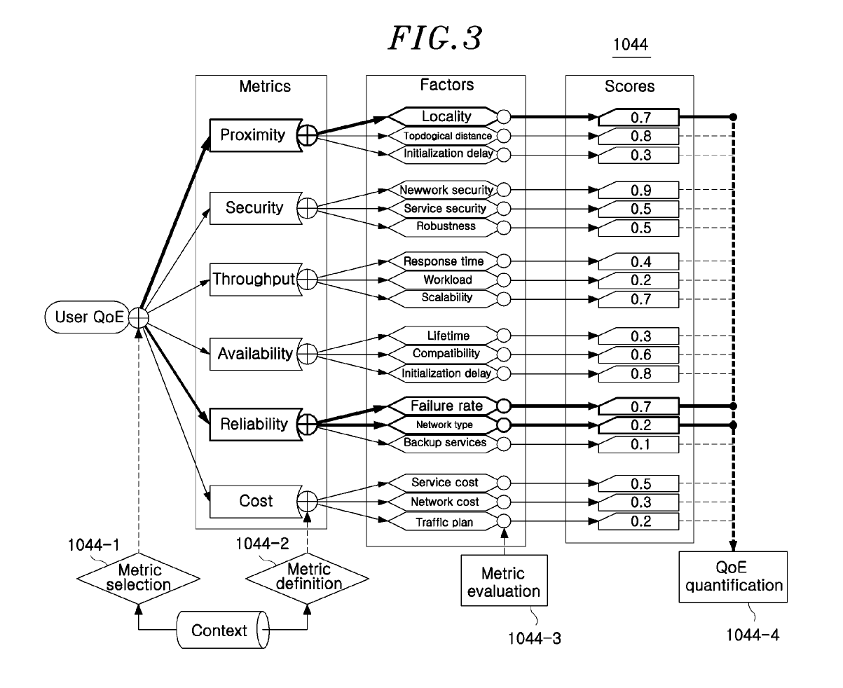

Further, the performance metric determination unit 1044 selects a performance metric to be applied to the composite service according to the service type and user's context, that is, determines a metric factor constructing each selected performance element. At this time, one or more metric factors among plural metric factors defined in advance can be selected, which will be described in detail with reference to FIG. 3 illustrating its detailed procedure.

FIG. 3 is a diagram illustrating an exemplary procedure in which the performance metric determination unit 1044 of FIG. 2 determines a 2-level performance element.

The performance metric determination unit 1044 executes several functions such as a metric factor definition 1044-2, a metric evaluation 1044-3 and a QoE determination 1044-4.

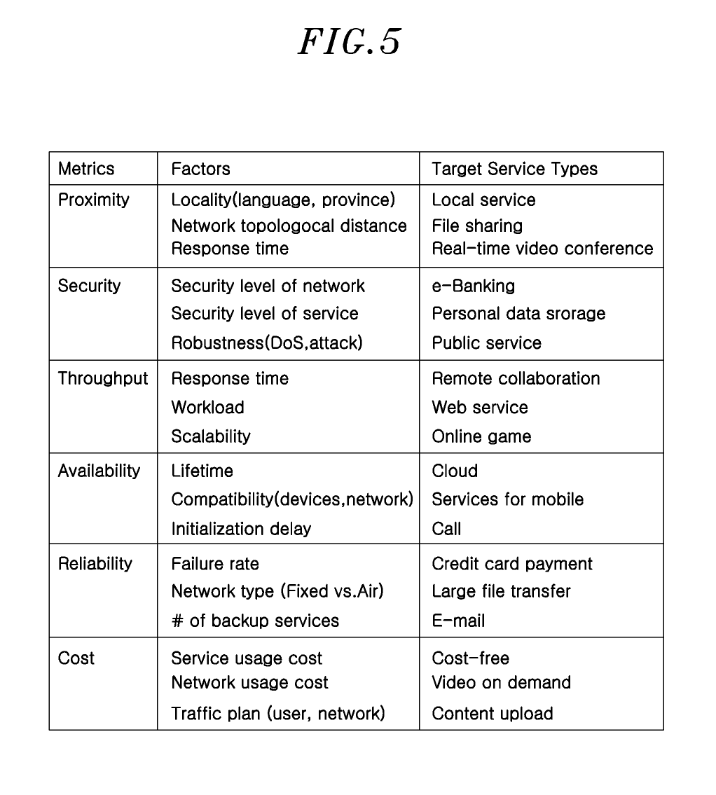

The metric selection 1044-1 provides functions such as selecting one or more metrics (performance elements) among several metrics defined in advance, for example, 6 metrics in consideration of user's characteristics (service type and user context) for each composite service. The 6 metrics defined herein and factors constructing each metric component are illustrated by way of example in FIG. 5, and may be defined as follows.

Proximity (regional location of service): regional distance, distance on a network topology, and distance on a response time

Security (security level of service): security level of network or service

Throughput (operation/transfer performance of service): response time, processing capacity, scalability

Availability (durability of service): service lifetime, compatibility on terminal and network, initial delay time

Reliability (reliability of service): failure rate, network type, the number of service back ups

Cost (service cost): expenditure to be paid when using service, expenditure to use network

While the embodiment suggests the above-described 6 performance elements as an example, this is only an exemplary suggestion for the convenience of simple description and to make better understanding. The present invention is not necessarily limited to the embodiment and other performance components may be added to it according to the need and use.

The metric factor definition 1044-2 provides functions such as determining one or more metric factors among plural metric factors defined in advance, for example, 3 metric factors, for one or more metrics selected through the metric selection 1044-1. Herein, the metric factor determination is defined according to service type and user's context.

The metric evaluation 1044-3 provides functions such as obtaining scores for evaluation of one or more metric factors determined correspondingly to one or more metrics selected through the metric factor definition 1044-2.

The QoE determination 1044-4 provides functions such as determining a metric having the relatively highest score among the scores obtained through the metric evaluation 1044-3 as the final metric (final performance metric) to be applied to the composite metric. The final metric determined here is transferred to the service graph evaluation unit 1045 of FIG. 2.

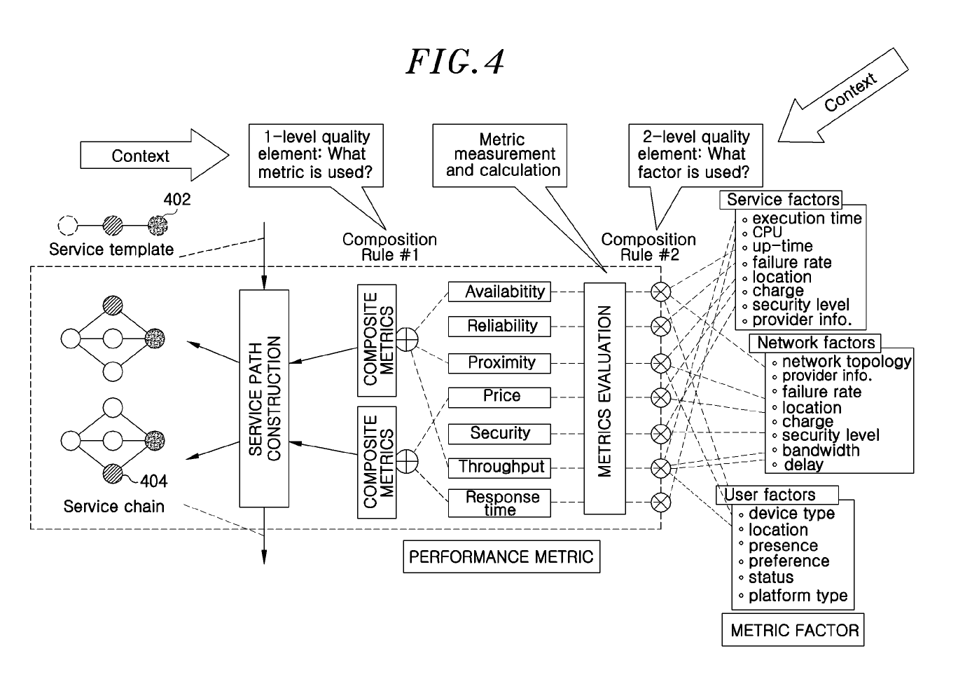

FIG. 4 is an exemplary diagram in which a service chain is constructed by applying a method for selecting performance metric and factor in accordance with the present invention. In FIG. 4, reference numerals 402 and 404 denote a service template and a service chain, respectively.

Referring to FIG. 4, in accordance with the present invention, a target performance metric is determined by executing processes such as selecting one or more 1-level performance components (quality component) according to contexts such as user, service and network (Metric selection), selecting one or more 2-level performance components according to context of user and service (Metric definition), measuring metric factor and calculating 2-level performance component (Metric evaluation), and calculating 1-level performance component using the calculated value of 2-level performance component (Metric quantification).

Herein, the evaluation component includes a performance metric that is a combination of a service performance component reflecting a user QoE (performance metric combination rule (#1): expression for one or more performance metric combinations); a metric factor that is a combination of factors defining metric (metric factor combination rule (#2): expression for one or more metric factor combination); a factor score that is a value produced by measuring factors); and a service score that is a value quantified by combining factor scores (used when comparing service quality/performance).

Referring again to FIG. 2, the service graph evaluation unit 1045 provides functions such as obtaining a performance index appropriate to each component service on the basis of the final performance metric that is provided from the performance metric determination block 1044, applying the performance index to the service graph produced through the service graph generation block 1043, and transferring the service graph produced to the service chain selection block 1046.

The service chain selection unit 1046 provides functions such as selecting component services appropriate to execution of the composite service utilizing context of user and service and constructing a service chain. The constructed service chain information is transferred to the service path generation unit 1047. In other words, the most appropriate service chain is determined by a requirement and current context requested by the composite service in the derived service graph. The determined service chain is comprised of a combination of component service instances embodying a service template that is given as a portion of the service graph and is a logical specification in which each operation order is defined in advance.

The service path generation unit 1047 provides functions such as determining a service path between service nodes on which the component services determined by the service chain derived through the service chain selection unit 1046 operate. The service path determined here is transferred to the service binding module 110. The service binding module 110 includes a service routing unit 1102 and a service execution unit 1104.

The service routing unit 1102 provides functions such as performing a routing of service node according to the service path given from the service path generation unit 1047 for the binding of the component service.

The service execution unit 1104 repeats operations of obtaining binding information of component service from the CSMF module 108 on the basis of the service chain provided from the service routing unit 1102, executing the component service bound on the local node through a service API mapping, that is, executing each component service in order on the basis of a routing path of nodes, and transferring its result to a next component service on the path. The result of such operations is transferred to a composite service which is a service requester (for example, an end-user or the like) or a destination determined in the service template.

As described above, it has been shown and described that the template of the composite service is executed by the service binding module. Alternatively, it is possible for the system of the embodiment to implement such that the template of the composite service may be executed by the SPCF module.

In accordance with the present invention as set forth above, the CCMF module collects context for user, service and network in responds to a request of the composite service. The SPCF module analyzes template of the composite service and extracts the component service types, searches for the component service instances appropriate to each component service type extracted with reference to the collected context and produces candidate services. The SPCF module also performs a mapping of the candidate services produced according to the component service types specified in the service template requested by the composite service and produces a service graph. Further, the SPCF module selects component services appropriate to execution of the composite service from the service graph according to requirement and current context requested by the composite service in the produced service graph and constructs the service chain. In addition, the SPCF module determines a service path between service nodes on which the selected component services operate with reference to context information of the network and makes the service binding module call component services according to the determined service path and execute the template of the composite service. Therefore, it is possible to select a service that optimizes a user's quality of experience (QoE) by differently applying the performance component of service according to the context of user, service and network, to provide the optimized service of the dynamic context change through the change of service performance component corresponding to the change of the context, to provide more optimized service by expanding performance metric and metric factor according to a variety of services and user requirements, and to realize reflection of more various and detailed requirement through change of the metric combination rule and factor combination rule.

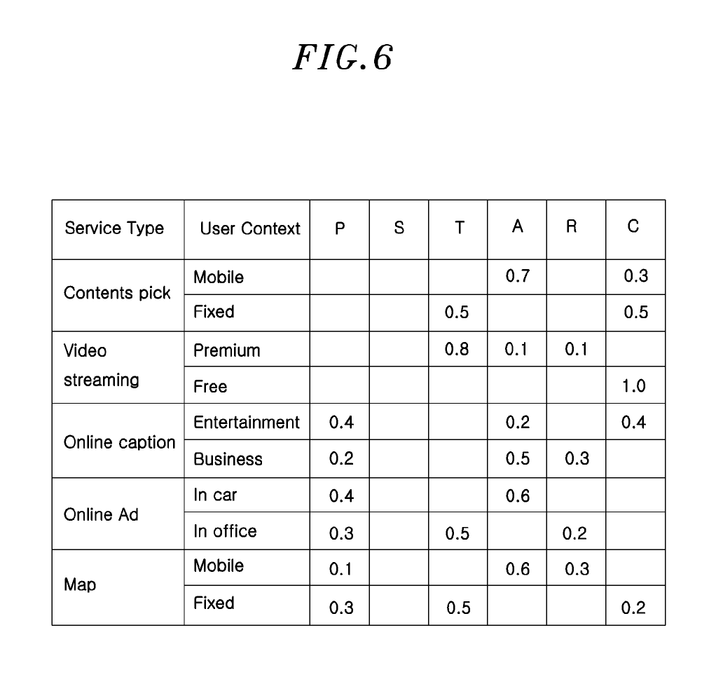

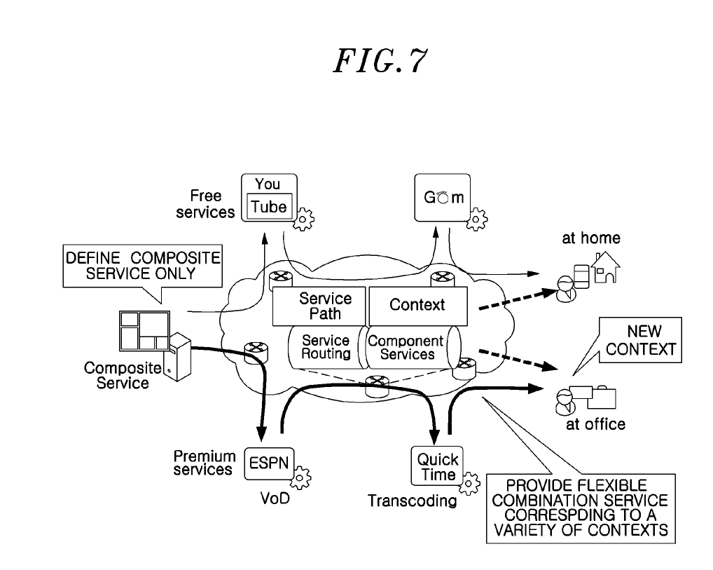

FIG. 6 is an exemplary diagram illustrating a combination of a performance metric (PSTARC (Proximity, Security, Throughput, Avalability, Reliabilty, and Cost)) according to service element and user context; and FIG. 7 is a diagram illustrating an example in which a service chain is adaptively constructed and a service is provided according to a context in a method for adaptive composite service path management in accordance with an embodiment of the present invention.

Referring to FIG. 7, under a user's context (context=home, free service), a service chain comprised of cost free component services (for example, You-Tube and GOM services) is constructed, and the relevant composite services is transferred. Further, under a new user's context (context =office, premium service), a service chain comprised of premium (charged) component services (for example, ESPN and Quick Time) is constructed and the relevant composite service is transferred.

For example, the system of the embodiment obtains the context and responds to it intelligently although there is no request indicated by a user, that is, the system recognizes a user's location (for example, at home) although the user did not request cost free services so that cost free services can be automatically selected and used through a reasoning of “Cost free services are required at home”.

Therefore, in accordance with the present invention, a flexible combination service is provided, which meets a variety of contexts of multiple user with respect to a composite service. That is, it will be possible to evaluate the service component by selectively combining service performance component and metric factor on the basis of the context as illustrated in FIG. 3 in order to select an appropriate service component according to context of each user in the above scenario.

While the invention has been described with respect to certain embodiments, the present invention is not limited thereto. It will be understood by those skilled in the art that various changes and modifications may be made without departing from the scope of the invention.

What is claimed is:

1. A system for adaptive composite service path management, the system comprising:
a service path control function module configured to search for and select component services according to a template of a composite service and generate a service chain and a service path on the basis of collected contexts from user, service and network; and
a service binding module configured to call the component services according to the service path and execute the template of the composite service.

2. The system of claim 1, further comprising a context management function module configured to collect and manage the context of the user, service and network.

3. The system of claim 1, wherein the service path control function module is further configured to analyze the template of the composite service and extract a type of the service, and obtain a component service instance list that is appropriate to the type of the extracted service.

4. The system of claim 3, wherein the service path control function module is further configured to generate a service graph for the obtained component service instance list and determine the service chain utilizing the context of the user and service.

5. The system of claim 1, wherein the service path control function module includes:
a service template extraction unit configured to extract a component service type list from the template of the composite service;
a service search unit configured to obtain a component service instance list that is appropriate to the extracted component service type;
a service graph generation unit configured to construct a combination of component service instances and producing a service graph that is a group of component services with which a requested composite service is embodied;
a performance metric determination unit configured to select metric to be applied to the composite service according to the context;
a service graph evaluation unit configured to obtain a performance index appropriate to each component service on the basis of the selected metric and applying the performance index to the produced service graph;
a service chain selection unit configured to select component services appropriate to execution of the composite service according to the applied service graph and constructing a service chain; and
a service path generation unit determine a service path between service nodes on which the determined component services operate.

6. The system of claim 5, wherein the template of the composite service comprises a specification portion to describe a service logic using business process execution language (BPEL) and a specification portion to describe the component service types using Web application description language (WADL).

7. The system of claim 5, wherein the performance metric determination unit is configured to perform:
a metric selection block for selecting one or more metrics among a number of matrix defined in advance;
a metric factor definition for determining one or more metric factors among a number of metric factors defined in advance for the one or more metrics selected;
a metric evaluation for obtaining a score to evaluate the one or more metric factors that are determined correspondingly to the one or more metrics selected; and
a QoE determination for determining a metric having the relatively highest score among the obtained scores as the final metric to be applied to the composite service.

8. The system of claim 7, wherein the metric selection unit selects the one or more metrics based on the context of the user and the type of the service.

9. The system of claim 7, wherein the metric factor determination determines the one or more metric factors based on the context of the user and the type of the service.

10. The system of claim 5, wherein the service chain selection constructs the service chain based on the context of the user and service.

11. The system of claim 1, wherein the service binding module includes:
a service routing unit configured to perform a routing of service node according to the service path given to bind component service; and
a service execution unit configured to obtain binding information of component service and executing the component service bound to a local node through a service API mapping.

12. A method for an adaptive composite service path management, the method comprising:
collecting context for user, service and network in response to a request of a composite service;
extracting a type of the service by analyzing a template of the composite service, and producing candidate services by searching for component service instances appropriate to the type of the service that are extracted with reference to the collected context;
producing a service graph by mapping the candidate services produced according to the type of the service for the service template requested by the composite service;
constructing a service chain by selecting component services appropriate to execution of the composite service from the service graph according to a requirement and a current context requested by the composite service;
determining a service path between service nodes on which component services operate, the component services being selected with reference to a context of a network;
calling the component services according to the determined service path to execute the template of the composite service.

13. The method of claim 12, wherein the template of the composite service includes a specification portion to describe a service logic using business process execution language (BPEL) and a specification portion to describe the component service types using Web application description language (WADL).

14. The method of claim 12, wherein the service chain comprises a combination of component service instances that embodies a service template given as a portion of the service graph.

15. The method of claim 14, wherein the service chain is constructed based on context of user and service.
